(19) United States
(12) Patent Application Publication
(10) Pub. No.: US 2025/0361397 A1
(43) Pub. Date: Nov. 27, 2025

(54) COPOLYESTERS COMPOSITIONS HAVING LOW COEFFICIENT OF FRICTION

(71) Applicant: Eastman Chemical Company, Kingsport, TN (US)

(72) Inventors: John Thomas Hofmann, Kingsport, TN (US); Katherine Augusta Hofmann, Kingsport, TN (US); Brandon Robert Williamson, Johnson City, TN (US)

(73) Assignee: Eastman Chemical Company, Kingsport, TN (US)

(21) Appl. No.: 18/872,848

(22) PCT Filed: Jun. 12, 2023
(86) PCT No.: PCT/US2023/068264

§ 371 Date: Dec. 9, 2024

Related U.S. Application Data
(60) Provisional application No. 63/366,290, filed on Jun. 13, 2022.

(51) Int. Cl. C08L 67/02

(52) U.S. Cl. CPC C08L 67/02; C08L 2205/035

(57) ABSTRACT

Provided are polymer compositions comprising copolyesters comprising 2,2,4,4-tetramethyl-1,3-cyclobutanediol (TMCD) and ethylene glycol (EG) residues which exhibit substantially improved impact toughness and coefficient of friction reduction while physical properties such as heat distortion temperature (HOT) and flexural modulus, after modification, are maintained compared to un-modified compositions.

### FIELD OF THE INVENTION

The invention belongs generally to the field of polymer science. In particular, the invention relates to certain copolyesters having low surface energy.

### BACKGROUND OF THE INVENTION

High molecular weight, thermoplastic linear copolyesters may generally be formed by reacting one or more diester with one or more diol under suitable polymerization conditions. Particular copolyesters that are useful in a wide variety of applications may be formed by reacting a diester composition comprising a dialkyl ester of terephthalic acid with a diol composition comprising a first diol component comprising 2,2,4,4-tetramethyl-1,3-cyclobutanediol (TMCD) and a second diol component comprising ethylene glycol (EG).

These copolyesters provide a desirable combination of performance parameters such as toughness, glass transition temperature, density, crystallization rate, melt viscosity and chemical resistance that translate to numerous benefits for both product manufacturers and the consumers who purchase these products. In a continuing effort to expand the sale, use and applicability of compositions that contain these copolyesters into new markets, however, polymer manufacturers seek to tailor composition characteristics and parameters to meet product manufacturer specifications in as-yet untapped product applications.

Copolyesters based on 2,2,4,4-tetramethyl-1,3-cyclobutanediol (TMCD) and ethylene glycol (EG) can have moderate-to-high surface energy. High surface energy can be advantageous for certain secondary operations (e.g., weldability, paintability, etc.), however polymeric articles made from compositions based on such copolyesters can have a moderate-to-high coefficient of friction (COF). Excessively high COF and lower impact toughness may result in polymeric articles that are inappropriate for use in durable applications which require repeated material-on-material interaction across a range of contact pressures. Manipulation of surface properties of polymers, for example the coefficient of friction by incorporation of additives can result in a corresponding substantial decrease in other physical properties or result in trade-offs in performance of the base resin.

Thus, a need exists for improved polymer compositions based on TMCD and EG, which have reduced coefficient of friction without compromising other desirable qualities of the polymer composition and the durable articles manufactured therefrom.

### SUMMARY OF THE INVENTION

The present invention provides a means to decrease the friction of copolyesters comprising TMCD and EG residues while substantially maintaining or improving impact toughness via incorporation of various additives. In one embodiment, reduction of the coefficient of friction was achieved by incorporation of additives including certain waxes and organo-siloxanes, while impact modification was achieved by incorporation of a wide-range of reactive and/or non-reactive impact modifiers. Further, certain embodiments of the invention also maintain clarity while improving impact toughness and decreasing coefficient of friction.

The frictionally modified, impact-toughened polymer compositions of the invention comprising residues of TMCD and EG exhibit a tunable frictional profile comparable with that of traditional engineering polymers such as acrylonitrile-butadiene-styrene polymers (ABS) or polycarbonates, capable of exhibiting similar frictional responses (static, kinetic coefficient of friction) across a wide range of contact pressures and part geometries. Notably, however, physical properties such as heat distortion temperature (HDT) and flexural modulus, after modification, are maintained compared to un-modified copolyester compositions, while impact toughness is markedly improved.

In embodiments, a polymer composition is provided that comprises a copolyester, one or more additives in an amount sufficient to reduce the coefficient of friction (COF) of the polymer composition, and one or more additives in an amount sufficient to increase impact toughness. The copolyester can comprise: a dicarboxylic acid component comprising terephthalic acid residues and a glycol component comprising: 2,2,4,4-tetramethyl-1,3-cyclobutanediol (TMCD) residues; and ethylene glycol (EG) residues; an inherent viscosity from 0.1 to 1.2 dL/g as determined in 60/40 (wt/wt) phenol/tetrachloroethane at a concentration of 0.5 g/100 ml at 25° C.; and a glass transition temperature (Tg) from 85 to 200° C. The one or more additives to reduce COF can be chosen from waxes and siloxanes.

Additives employed for frictional modification can include small-molecule waxes to high-molecular weight organo-siloxanes. In embodiments, additives can be incorporated at loadings from 0.1 wt % to 12 wt %, depending on the frictional additive(s) selected.

In embodiments, the one or more additives to increase impact toughness can be chosen from elastomeric compounds or polymers which serve to absorb or dissipate the kinetic energy of an impact.

### DETAILED DESCRIPTION OF THE INVENTION

In a first aspect, the invention provides a polymer composition comprising:
(a) a copolyester comprising: (i) diacid residues comprising from about 90 to 100 mole percent of terephthalic acid residues and from 0 to about 10 mole percent isophthalic acid residues; and (ii) diol residues comprising 58 to 95 mole percent of ethylene glycol residues; and 5 to 42 mole percent of 2,2,4,4-tetramethyl-1,3-cyclobutanediol residues, wherein the copolyester comprises a total of 100 mole percent diacid residues and a total of 100 mole percent diol residues.
(b) about 0.1 to about 12 weight percent of a frictional additive chosen from waxes and siloxanes; and
(c) about 0.5 to about 15 weight percent of at least one impact modifier.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present invention, therefore, may be based on the total moles of acid residues, the total moles of diol residues, or the total moles of repeating units.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present invention. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein.

Esters of terephthalic acid and the other dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In certain embodiments, the polyester composition comprises a copolyester comprising: (a) diacid residues comprising from about 90 to 100 mole percent of TPA residues and from 0 to about 10 mole percent IPA residues; and (b) diol residues comprising at 58 to 95 mole percent of EG residues; and 5 to 42 mole percent of TMCD residues, wherein the copolyester comprises a total of 100 mole percent diacid residues and a total of 100 mole percent diol residues.

In embodiments, the copolyester comprises diol residues comprising from 10 to 42 mole percent TMCD residues and 58 to 90 mole percent EG residues. In one embodiment, the copolyester comprises diol residues comprising 5 to 40 mole percent TMCD residues and 60 to 95 mole percent EG residues.

In embodiments, the copolyester comprises diol residues comprising 20 to 37 mole percent TMCD residues and 63 to 80 mole percent EG residues. In one embodiment, the copolyester comprises diol residues comprising 22 to 35 mole percent TMCD residues and 65 to 78 mole percent EG residues.

In embodiments, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 10 to about 27 mole % 2,2,4,4-tetramethyl-1,3-cyclobutanediol (TMCD) residues; and (ii) about 90 to about 73 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.8 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component of the copolyester comprises: (i) about 15 to about 25 mole % 2,2,4,4-tetramethyl-1,3-cyclobutanediol (TMCD) residues; and (ii) about 85 to about 75 mole % ethylene glycol residues; or (i) about 20 to about 25 mole % 2,2,4,4-tetramethyl-1,3-cyclobutanediol (TMCD) residues; and (ii) about 80 to about 75 mole % ethylene glycol residues; or (i) about 21 to about 24 mole % 2,2,4,4-tetramethyl-1,3-cyclobutanediol (TMCD) residues; and (ii) about 76 to about 79 mole % ethylene glycol residues.

In one embodiment, the copolyester comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising:
   (i) about 10 to about 27 mole % 2,2,4,4-tetramethyl-1,3-cyclobutanediol residues; and
   (ii) about 73 to about 90 mole % ethylene glycol residues, and
   (iii) less than about 5 mole %, or less than 2 mole %, of any other modifying glycols;
wherein the total mole % of the dicarboxylic acid component is 100 mole %, and
wherein the total mole % of the glycol component is 100 mole %; and wherein the inherent viscosity of the copolyester is from 0.50 to 0.8 dL/g as determined in 60/40 (wt/wt) phenol/tetrachloroethane at a concentration of 0.25 g/50 ml at 25° C.

In embodiments, the copolyester has at least one of the following properties chosen from: a Tg of from about 90 to about 108° C. as measured by a TA 2100 Thermal Analyst Instrument at a scan rate of 20° C./min, a flexural modulus at 23° C. of greater than about 2000 MPa (290,000 psi) as defined by ASTM D790, and a notched Izod impact strength greater than about 25 J/m (0.47 ft-lb/in) according to ASTM D256 with a 10-mil notch using a ⅛-inch thick bar at 23° C. In one embodiment, the L* color values for the copolyester is 90 or greater, or greater than 90, as determined by the L*a*b* color system measured following ASTM D 6290-98 and ASTM E308-99, performed on polymer granules ground to pass a 1 mm sieve.

In one embodiment, the copolyester further comprises: (II) a catalyst/stabilizer component comprising: (i) titanium atoms in the range of 10-50 ppm based on polymer weight, (ii) optionally, manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In embodiments, the glycol component for the copolyesters can include but are not limited to at least one of the following combinations of ranges: about 10 to about 30 mole % 2,2,4,4-tetramethyl-1,3-cyclobutanediol and about 90 to about 70 mole % ethylene glycol; about 10 to about 27 mole % 2,2,4,4-tetramethyl-1,3-cyclobutanediol and about 90 to about 73 mole % ethylene glycol; about 15 to about 26 mole % 2,2,4,4-tetramethyl-1,3-cyclobutanediol and about 85 to about 74 mole % ethylene glycol; about 18 to about 26 mole % 2,2,4,4-tetramethyl-1,3-cyclobutanediol and about 82 to about 77 mole % ethylene glycol; about 20 to about 25 mole % 2,2,4,4-tetramethyl-1,3-cyclobutanediol and about 80 to about 75 mole % ethylene glycol; about 21 to about 24 mole % 2,2,4,4-tetramethyl-1,3-cyclobutanediol and about 79 to about 76 mole % ethylene glycol; or about 22 to about 24 mole % 2,2,4,4-tetramethyl-1,3-cyclobutanediol and about 78 to about 76 mole % ethylene glycol.

In certain embodiments, the copolyesters may exhibit at least one of the following inherent viscosities as determined in 60/40 (wt/wt) phenol/tetrachloroethane at a concentration of 0.25 g/50 ml at 25° C. from 0.50 to 0.8 dL/g; 0.55 to 0.75 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or about 0.65 dL/g.

In certain embodiments, the Tg of the copolyester can be chosen from one of the following ranges: 85 to 100° C.; 86 to 99° C.; 87 to 98° C.; 88 to 97° C.; 89 to 96° C.; 90 to 95° C.; 91 to 95° C.; 92 to 94° C.

In another embodiment, the copolyester comprises diol residues comprising 30 to 42 mole percent TMCD residues and 58 to 70 mole percent EG residues. In one embodiment, the copolyester comprises diol residues comprising 33 to 38 mole percent TMCD residues and 62 to 67 mole percent EG residues.

In embodiments, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 30 to about 42 mole % 2,2,4,4-tetramethyl-1,3-cyclobutanediol (TMCD) residues; and (ii) about 70 to about 58 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.70 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component comprises: (i) about 32 to about 42 mole % 2,2,4,4-tetramethyl-1,3-cyclobutanediol (TMCD) residues, and (ii) about 68 to about 58 mole % ethylene glycol residues; or (i) about 34 to about 40 mole % 2,2,4,4-tetramethyl-1,3-cyclobutanediol (TMCD) residues, and (ii) about 66 to about 60 mole % ethylene glycol residues; or (i) greater than 34 to about 40 mole % 2,2,4,4-tetramethyl-1,3-cyclobutanediol (TMCD) residues, and (ii) less than 66 to about 60 mole % ethylene glycol residues; or (i) 34.2 to about 40 mole % 2,2,4,4-tetramethyl-1,3-cyclobutanediol (TMCD) residues, and (ii) 65.8 to about 60 mole % ethylene glycol residues; or (i) about 35 to about 39 mole % 2,2,4,4-tetramethyl-1,3-cyclobutanediol (TMCD) residues, and (ii) about 65 to about 61 mole % ethylene glycol residues; or (i) about 36 to about 37 mole % 2,2,4,4-tetramethyl-1,3-cyclobutanediol (TMCD) residues; and (ii) about 64 to about 63 mole % ethylene glycol residues.

In one embodiment, the copolyester comprises:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising:
   (i) about 30 to about 42 mole % 2,2,4,4-tetramethyl-1,3-cyclobutanediol residues; and
   (ii) about 70 to about 58 mole % ethylene glycol residues, and
   (iii) less than about 5 mole %, or less than 2 mole %, of any other modifying glycols;
wherein the total mole % of the dicarboxylic acid component is 100 mole %, and
wherein the total mole % of the glycol component is 100 mole %; and
wherein the inherent viscosity of the polyester is from 0.50 to 0.70 dL/g as determined in 60/40 (wt/wt) phenol/tetrachloroethane at a concentration of 0.25 g/50 ml at 25° C.

In embodiments, the copolyester has at least one of the following properties chosen from: a T_{g} of from about 100 to about 110° C. as measured by a TA 2100 Thermal Analyst Instrument at a scan rate of 20° C./min, a flexural modulus at 23° C. of equal to or greater than 2000 MPa (about 290,000 psi), or greater than 2200 MPa (319,000 psi) as defined by ASTM D790, a notched Izod impact strength of about 30 J/m (0.56 ft-lb/in) to about 80 J/m (1.50 ft-lb/in) according to ASTM D256 with a 10-mil notch using a ⅛-inch thick bar at 23° C., and less than 5% loss in inherent viscosity after being held at a temperature of 293° C. (560° F.) for 2 minutes. In one embodiment, the L* color values for the polyester composition is 90 or greater, or greater than 90, as determined by the L*a*b* color system measured following ASTM D 6290-98 and ASTM E308-99, performed on polymer granules ground to pass a 1 mm sieve.

In one embodiment, the copolyester comprises a diol component having at least 30 mole percent TMCD residues (based on the diols) and a catalyst/stabilizer component comprising: (i) titanium atoms in the range of 10-60 ppm based on polymer weight, (ii) manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In embodiments, the glycol component for the copolyesters includes but is not limited to at least one of the following combinations of ranges: about 30 to about 42 mole % 2,2,4,4-tetramethyl-1,3-cyclobutanediol and about 58 to 70 mole % ethylene glycol; about 32 to about 42 mole % 2,2,4,4-tetramethyl-1,3-cyclobutanediol and about 58 to 68 mole % ethylene glycol; about 32 to about 36 mole % 2,2,4,4-tetramethyl-1,3-cyclobutanediol and about 64 to 68 mole % ethylene glycol; about 33 to about 41 mole % 2,2,4,4-tetramethyl-1,3-cyclobutanediol and about 59 to 67 mole % ethylene glycol; about 34 to about 40 mole % 2,2,4,4-tetramethyl-1,3-cyclobutanediol and about 60 to 66 mole % ethylene glycol; greater than 34 to about 40 mole % 2,2,4,4-tetramethyl-1,3-cyclobutanediol and 60 to less than 66 mole % ethylene glycol; 34.2 to 40 mole % 2,2,4,4-tetramethyl-1,3-cyclobutanediol and about 60 to 65.8 mole % ethylene glycol; about 35 to about 39 mole % 2,2,4,4-tetramethyl-1,3-cyclobutanediol and about 61 to 65 mole % ethylene glycol; about 35 to about 38 mole % 2,2,4,4-tetramethyl-1,3-cyclobutanediol and about 62 to 65 mole % ethylene glycol; or about 36 to about 37 mole % 2,2,4,4-tetramethyl-1,3-cyclobutanediol and about 63 to 64 mole % ethylene glycol.

In certain embodiments, the polyesters may exhibit at least one of the following inherent viscosities as determined in 60/40 (wt/wt) phenol/tetrachloroethane at a concentration of 0.25 g/50 ml at 25° C. from 0.50 to 0.70 dL/g; 0.55 to 0.65 dL/g; 0.56 to 0.64 dL/g; 0.56 to 0.63 dL/g; 0.56 to 0.62 dL/g; 0.56 to 0.61 dL/g; 0.57 to 0.64 dL/g; 0.58 to 0.64 dL/g; 0.57 to 0.63 dL/g; 0.57 to 0.62 dL/g; 0.57 to 0.61 dL/g; 0.58 to 0.60 dL/g or about 0.59 dL/g.

In embodiments, the copolyester comprises 0 to 10 mole percent of CHDM residues. In certain embodiments, the copolyester can contain less than 10 mole %, or less than 5 mole %, or less than 4 mole %, or less than 3 mole %, or less than 2 mole %, or less than 1 mole %, or no, CHDM residues.

In embodiments, the polyesters can be made from monomers that contain no 1,3-propanediol, or 1,4-butanediol, either singly or in combination. In other aspects, 1,3-propanediol or 1,4-butanediol, either singly or in combination, may be used in the making of the polyesters useful in this invention.

In embodiments, the mole % of cis-2,2,4,4-tetramethyl-1,3-cyclobutanediol in certain polyesters is greater than 50 mole % or greater than 55 mole % of cis-2,2,4,4-tetramethyl-1,3-cyclobutanediol or greater than 70 mole % of cis-2,2,4,4-tetramethyl-1,3-cyclobutanediol; wherein the total mole percentage of cis-2,2,4,4-tetramethyl-1,3-cyclobutanediol and trans-2,2,4,4-tetramethyl-1,3-cyclobutanediol is equal to a total of 100 mole %.

In embodiments, the mole % of the isomers of 2,2,4,4-tetramethyl-1,3-cyclobutanediol in certain polyesters is from 30 to 70 mole % of cis-2,2,4,4-tetramethyl-1,3-cyclobutanediol or from 30 to 70 mole % of trans-2,2,4,4-tetramethyl-1,3-cyclobutanediol, or from 40 to 60 mole % of cis-2,2,4,4-tetramethyl-1,3-cyclobutanediol or from 40 to 60 mole % of trans-2,2,4,4-tetramethyl-1,3-cyclobutanediol, wherein the total mole percentage of cis-2,2,4,4-tetramethyl-1,3-cyclobutanediol and trans-2,2,4,4-tetramethyl-1,3-cyclobutanediol is equal to a total of 100 mole %.

In certain embodiments, the polyesters can be amorphous or semi-crystalline. In one aspect, certain polyesters can have a relatively low crystallinity. Certain polyesters can thus have a substantially amorphous morphology, meaning that the polyesters comprise substantially unordered regions of polymer.

In embodiments, the polyester(s) and/or polyester composition(s) can have a unique combination of two or more physical properties such as high impact strengths, moderate to high glass transition temperatures, chemical resistance, hydrolytic stability, toughness, low ductile-to-brittle transition temperatures, good color and clarity, low densities, long crystallization half-times, and good processability thereby easily permitting them to be formed into articles. In some of the embodiments, the polyesters can have a unique combination of the properties of good impact strength, heat resistance, chemical resistance, density and/or the combination of the properties of good impact strength, heat resistance, and processability and/or the combination of two or more of the described properties.

In embodiments, the polyesters can be prepared from dicarboxylic acids and diols which react in substantially equal proportions and are incorporated into the polyester polymer as their corresponding residues. The polyesters, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

In embodiments, the Tg of the polyesters can be at least one of the following ranges: 100 to 200° C.; 100 to 190° C.; 100 to 180° C.; 100 to 170° C.; 100 to 160° C.; 100 to 155° C.; 100 to 150° C.; 100 to 145° C.; 100 to 140° C.; 100 to 138° C.; 100 to 135° C.; 100 to 130° C.; 100 to 125° C.; 100 to 120° C.; 100 to 115° C.; 100 to 110° C.; 105 to 200° C.; 105 to 190° C.; 105 to 180° C.; 105 to 170° C.; 105 to 160° C.; 105 to 155° C.; 105 to 150° C.; 105 to 145° C.; 105 to 140° C.; 105 to 138° C.; 105 to 135° C.; 105 to 130° C.; 105 to 125° C.; 105 to 120° C.; 105 to 115° C.; 105 to 110° C. greater than 105 to 125° C.; greater than 105 to 120° C.; greater than 105 to 115° C.; greater than 105 to 110° C.; 110 to 200° C.; 110 to 190° C.; 110 to 180° C.; 110 to 170° C.; 110 to 160° C.; 110 to 155° C.; 110 to 150° C.; 110 to 145° C.; 110 to 140° C.; 110 to 138° C.; 110 to 135° C.; 110 to 130° C.; 110 to 125° C.; 110 to 120° C.; 110 to 115° C.; 115 to 200° C.; 115 to 190° C.; 115 to 180° C.; 115 to 170° C.; 115 to 160° C.; 115 to 155° C.; 115 to 150° C.; 115 to 145° C.; 115 to 140° C.; 115 to 138° C.; 115 to 135° C.; 110 to 130° C.; 115 to 125° C.; 115 to 120° C.; 120 to 200° C.; 120 to 190° C.; 120 to 180° C.; 120 to 170° C.; 120 to 160° C.; 120 to 155° C.; 120 to 150° C.; 120 to 145° C.; 120 to 140° C.; 120 to 138° C.; 120 to 135° C.; 120 to 130° C.; 125 to 200° C.; 125 to 190° C.; 125 to 180° C.; 125 to 170° C.; 125 to 160° C.; 125 to 155° C.; 125 to 150° C.; 125 to 145° C.; 125 to 140° C.; 125 to 138° C.; 125 to 135° C.; 127 to 200° C.; 127 to 190° C.; 127 to 180° C.; 127 to 170° C.; 127 to 160° C.; 127 to 150° C.; 127 to 145° C.; 127 to 140° C.; 127 to 138° C.; 127 to 135° C.; 130 to 200° C.; 130 to 190° C.; 130 to 180° C.; 130 to 170° C.; 130 to 160° C.; 130 to 155° C.; 130 to 150° C.; 130 to 145° C.; 130 to 140° C.; 130 to 138° C.; 130 to 135° C.; 135 to 200° C.; 135 to 190° C.; 135 to 180° C.; 135 to 170° C.; 135 to 160° C.; 135 to 155° C.; 135 to 150° C.; 135 to 145° C.; 135 to 140° C.; 140 to 200° C.; 140 to 190° C.; 140 to 180° C.; 140 to 170° C.; 140 to 160° C.; 140 to 155° C.; 140 to 150° C.; 140 to 145° C.; 148 to 200° C.; 148 to 190° C.; 148 to 180° C.; 148 to 170° C.; 148 to 160° C.; 148 to 155° C.; 148 to 150° C.; 150 to 200° C.; 150 to 190° C.; 150 to 180° C.; 150 to 170° C.; 150 to 160° C.; 155 to 190° C.; 155 to 180° C.; 155 to 170° C.; and 155 to 165° C.

For certain embodiments, the polyesters may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the polyesters may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dug to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98 dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98 dL/g; greater than 0.80 dL/g to 0.95 dL/g; greater than 0.80 dL/g to 0.90 dL/g.

In certain embodiments, it is contemplated that the polyester compositions can possess at least one of the inherent viscosity ranges described herein and at least one of the monomer ranges for the compositions described herein unless otherwise stated. It is also contemplated that the polyester compositions can possess at least one of the Tg ranges described herein and at least one of the monomer ranges for the compositions described herein unless otherwise stated. It is also contemplated that the polyester compositions can possess at least one of the Tg ranges described herein, at least one of the inherent viscosity ranges described herein, and at least one of the monomer ranges for the compositions described herein unless otherwise stated.

In embodiments, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexandimethanol can vary within the range of 50/50 to 0/100, such as between 40/60 to 20/80.

In certain embodiments, terephthalic acid or an ester thereof, such as, for example, dimethyl terephthalate, or a mixture of terephthalic acid and an ester thereof, makes up most, or all, of the dicarboxylic acid component used to form the polyesters. In certain embodiments, terephthalic acid residues can make up a portion or all of the dicarboxylic acid component used to form the polyester at a concentration of at least 70 mole %, such as at least 80 mole %, at least 90 mole %, at least 95 mole %, at least 99 mole %, or 100 mole %. In certain embodiments, higher amounts of terephthalic acid can be used to produce a higher impact strength polyester. In one embodiment, dimethyl terephthalate is part or all of the dicarboxylic acid component used to make the polyesters useful in the present invention. For the purposes of this disclosure, reference to residues of “terephthalic acid” and “dimethyl terephthalate” are used interchangeably herein. For example, reference to polymer residues of terephthalic acid (TPA) also includes polymer residues derived from dimethyl terephthalate (DMT). In all embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, in certain embodiments the dicarboxylic acid component of the polyester can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole %. In one embodiment, modifying aromatic dicarboxylic acids that may be used include but are not limited to those having up to 20 carbon atoms, and which can be linear, para-oriented, or symmetrical. Examples of modifying aromatic dicarboxylic acids which may be used include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

In embodiments, the carboxylic acid component of the polyesters can be further modified with up to 10 mole %, such as up to 5 mole % or up to 1 mole % of one or more aliphatic dicarboxylic acids containing 2-16 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In embodiments for polyesters containing CHDM, the 1,4-cyclohexanedimethanol may be cis, trans, or a mixture thereof, for example a cis/trans ratio of 60:40 to 40:60.

In embodiments, the polyester(s) can be linear or branched. In embodiments, the polycarbonate (if included) can also be linear or branched. In certain embodiments, a branching monomer or agent may be added prior to and/or during and/or after the polymerization of the polycarbonate.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The glass transition temperature (Tg) of the polyesters can be determined using a TA DSC 2920 from Thermal Analyst Instrument at a scan rate of 20° C./min.

Long crystallization half-times (e.g., greater than 5 minutes) at 170° C. exhibited by certain of the polyesters, can be beneficial for production of certain injection molded, compression molded, and solution casted articles. The polyesters can be amorphous or semi-crystalline. In one aspect, certain polyesters can have relatively low crystallinity. Certain polyesters can thus have a substantially amorphous morphology, meaning that the polyesters comprise substantially unordered regions of polymer.

In one embodiment, an “amorphous” polyester can have a crystallization half-time of greater than 5 minutes at 170° C. or greater than 10 minutes at 170° C. or greater than 50 minutes at 170° C. or greater than 100 minutes at 170° C. In one embodiment, the crystallization half-times are greater than 1,000 minutes at 170° C. In another embodiment of the invention, the crystallization half-times of the polyesters useful in the invention are greater than 10,000 minutes at 170° C. The crystallization half time of the polyester, as used herein, may be measured using methods well-known to persons of skill in the art. For example, the crystallization half time of the polyester, t_{1/2}, can be determined by measuring the light transmission of a sample via a laser and photo detector as a function of time on a temperature controlled hot stage. This measurement can be done by exposing the polymers to a temperature, Tₘₐₓ, and then cooling it to the desired temperature. The sample can then be held at the desired temperature by a hot stage while transmission measurements are made as a function of time. Initially, the sample can be visually clear with high light transmission and becomes opaque as the sample crystallizes. The crystallization half-time is the time at which the light transmission is halfway between the initial transmission and the final transmission. Tₘₐₓ is defined as the temperature required to melt the crystalline domains of the sample (if crystalline domains are present). The sample can be heated to Tₘₐₓ to condition the sample prior to crystallization half time measurement. The absolute Tₘₐₓ temperature is different for each composition. For example, PCT can be heated to some temperature greater than 290° C. to melt the crystalline domains.

In embodiments, certain polyesters are visually clear. The term “visually clear” is defined herein as an appreciable absence of cloudiness, haziness, and/or muddiness, when inspected visually. In one embodiment, when the polyesters are blended with polycarbonate, including bisphenol A polycarbonates, the blends can be visually clear. In embodiments, the polyesters can possess one or more of the properties described herein. In embodiments, the polyesters can have a yellowness index (ASTM D-1925) of less than 50, such as less than 20.

The copolyester portion of the polymer compositions of the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In general, the copolyesters may be prepared by a process comprising: (I) heating a mixture comprising the monomers useful in any of the polyesters in the invention in the presence of a catalyst at a temperature of 150 to 240° C. for a time sufficient to produce an initial polyester; (II) heating the initial polyester of step (I) at a temperature of 240 to 320° C. for 1 to 4 hours; and (III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or 10 to 5000 ppm or 10 to 1000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50% by weight or more of the 2,2,4,4-tetramethyl-1,3-cyclobutanediol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging from 0.002 psig to below atmospheric pressure, or by blowing hot nitrogen gas over the mixture.

In embodiments, the polyester composition can be a polymer blend, wherein the blend comprises: (a) 5 to 95 wt % of at least one of the polyesters described herein; and (b) 5 to 95 wt % of at least one polymeric component. Suitable examples of polymeric components include, but are not limited to, nylon, polyesters different from those described herein, polyamides such as ZYTEL® from DuPont; polystyrene, polystyrene copolymers, styrene acrylonitrile copolymers, acrylonitrile butadiene styrene copolymers, poly(methylmethacrylate), acrylic copolymers, poly(ether-imides) such as ULTEM™ resin (a poly(ether-imide) from SABIC); polyphenylene oxides such as poly(2,6-dimethylphenylene oxide) or poly(phenylene oxide)/polystyrene blends such as NORYL™ resin (a blend of poly(2,6-dimethylphenylene oxide) and polystyrene resins from SABIC); polyphenylene sulfides; polyphenylene sulfide/sulfones; poly(ester-carbonates); polycarbonates such as LEXAN® (a polycarbonate from SABIC); polysulfones; polysulfone ethers; and poly(ether-ketones) of aromatic dihydroxy compounds; or mixtures of any of the other foregoing polymers. The blends can be prepared by conventional processing techniques known in the art, such as melt blending or solution blending. In one embodiment, the polycarbonate is not present in the polyester composition. If polycarbonate is used in a blend in the polyester compositions useful in the invention, the blends can be visually clear. However, the polyester compositions useful in the invention also contemplate the exclusion of polycarbonate as well as the inclusion of polycarbonate.

In addition to the additive and optional impact modifiers (as discussed herein), the polyester compositions and the polymer blend compositions may also contain additional additives chosen from antioxidants, thermal stabilizers, mold release agents, antistatic agents, whitening agents, colorants, flow aids, processing aids, plasticizers, anti-fog additives, minerals, UV stabilizers, lubricants, chain extenders, nucleating agents, reinforcing fillers, other fillers, glass fiber, carbon fiber, flame retardants, dyes, pigments, colorants, additional resins and combinations thereof. In certain embodiments, the polyester compositions and the polymer blend compositions may also contain from 0.01 to 25% by weight of the overall composition common additives such as colorants, dyes, mold release agents, flame retardants, plasticizers, nucleating agents, stabilizers, including but not limited to, UV stabilizers, thermal stabilizers and/or reaction products thereof, and fillers. For example, UV additives can be incorporated into the articles (e.g., ophthalmic product(s)) through addition to the bulk or in the hard coat.

In some embodiments, during the process for making the polyesters useful in the present invention, certain agents which colorize the polymer can be added to the melt including toners or dyes. In one embodiment, a bluing toner is added to the melt in order to adjust the b* of the resulting polyester polymer melt phase product. Such bluing agents include blue inorganic and organic toner(s) and/or dyes. In addition, red toner(s) and/or dyes can also be used to adjust the a* color. In one embodiment, the polymers or polymer blends useful in the invention and/or the polymer compositions of the invention, with or without toners, can have color values L*, a* and b* which can be determined using a Hunter Lab Ultrascan Spectra Colorimeter manufactured by Hunter Associates Lab Inc., Reston, Va. The color determinations are averages of values measured on either pellets or powders of the polymers or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Advantageously, the toner(s) are added to the esterification zone or to the early stages of the polycondensation zone, such as to a pre-polymerization reactor or added in an extruder or calender during processing.

In embodiments, the polyesters can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally from 0.1 percent by weight to 10 percent by weight, such as from 0.1 to 5 percent by weight, based on the total weigh of the polyester.

Thermal stabilizers are compounds that stabilize polyesters during polyester manufacture and/or post polymerization, including, but not limited to, phosphorous compounds, including, but not limited to, phosphoric acid, phosphorous acid, phosphonic acid, phosphinic acid, phosphonous acid, and various esters and salts thereof. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive. In embodiments, these can be present in the polyester compositions.

In embodiments, reinforcing materials may be useful in the polyester compositions. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials are glass, such as, fibrous glass filaments, mixtures of glass and talc, glass and mica, and glass and polymeric fibers.

In another embodiment, the invention further relates to articles of manufacture comprising any of the polyesters and blends described herein. extruded, calendered, and/or molded articles including but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles, and extrusion stretch blow molded articles. These articles can include, but are not limited, to films, bottles (including, but not limited to, baby bottles), containers, sheet and/or fibers.

In embodiments, the articles can be intended for applications where an article (or a component thereof) has surface to surface contact (with another article or component) where movement is contemplated at that surface contact, e.g., where it is contemplated that surfaces may slide against each other. Such applications can include articles, parts or components that are releasably connected to each other, e.g., by a frictional connection. Examples of such applications can include durable articles or toys (e.g., construction toys) having articles, parts or components that interact in use as described above. In embodiments, the polyester compositions or articles made therefrom can be applications that currently are made from ABS plastic (e.g., general toys, electronics, or medical devices). Additional examples of articles can include clear or opaque food-contact applications, e.g., food containers, lids, bottles, including sports bottles and lids, and fasteners and hinges for same, including fastener and hinge integrated components and/or assemblies.

The present copolyesters and/or polyester blend compositions can be useful in forming fibers, films, molded articles, containers, and sheeting. The methods of forming the polyesters into fibers, films, molded articles, containers, and sheeting are well known in the art. Examples of potential molded articles include without limitation: medical devices such as dialysis equipment, medical packaging, healthcare supplies, commercial food service products such as food pans, tumblers and storage boxes, baby bottles, food processors, blender and mixer bowls, utensils, water bottles, crisper trays, toys, washing machine fronts, and vacuum cleaner parts, as well as lids, latches and hinges associated with the above.

In another embodiment, the invention further relates to articles of manufacture comprising the film(s) and/or sheet(s) containing polyester compositions described herein.

The films and/or sheets useful in the present invention can be of any thickness which would be apparent to one of ordinary skill in the art. In one embodiment, the film(s) of the invention have a thickness of no more than 40 mils. In one embodiment, the film(s) of the invention have a thickness of no more than 35 mils. In one embodiment, the film(s) of the invention have a thickness of no more than 30 mils. In one embodiment, the film(s) of the invention have a thickness of no more than 25 mils. In one embodiment, the film(s) of the invention have a thickness of no more than 20 mils.

In embodiments, the (frictional) additives may be chosen from a broad range of waxes and siloxanes. The waxes useful in the polymer compositions of the invention can include known higher alkanes and lipids, which are lipophilic, malleable solids at room temperature (i.e., 23° C.). Natural waxes are found in plants and animals and also occur in petroleum products. In one embodiment, the waxes are mixtures of saturated alkanes, naphthenes, and alkyl and naphthene-substituted aromatic compounds. In another embodiment, the wax can be a Montan wax, which is extracted from certain coal and lignite sources. In another embodiment, the wax can be a polyolefin or a polyalkylene wax. Naturally-occurring waxes can include beeswax, which is primarily myricyl palmitate, cetyl palmitate, lanolin, carnuba wax. In another embodiment, the wax can be a rice bran wax (RBW), e.g., RBW derived from crude rice bran, such as LICOCARE® RBW Vita additives (from Clariant).

In embodiments, the siloxanes can be compounds comprising the Si—O—Si linkage. Examples include compounds having the structures H(OSiH2)nOH and (OSiH2)n. In other embodiments, the siloxanes can be silicones or polysiloxanes having the structure (—RSi—O—SiR—), wherein R is an organic group such as an alkyl or aryl group. Examples of such polysiloxanes are polydimethylsiloxane or “PDMS” and polydiphenylsiloxane.

Commercially available examples of waxes and siloxanes can include Genioplast S, a pellitized silicone gum formulation from Wacker Chemie AG; Tegomer H-Si (e.g., H-Si 6441 P) (polyester modified siloxanes), Tegomer V-Si (e.g., V-Si 4042) (vinyl terminated organo-modified silicone (OMS)), Tegomer M-Si (e.g., M-Si 2650) (aryl terminated OMS), Tegomer E-Si (e.g., E-Si 2330) (epoxy terminated OMS), or Tegomer DA 800 (copolyester dispersion), all from Evonik Industries AG; MCR-E21 or ECMS-227 functionalized siloxanes, from Gelest; Dowsil™ Si powder resin modifier, or DowSil 4-7081, from the Dow Chemical Company; Loxiol P or P861, polyol esters, from Emery Oleochemicals GmbH; Modiper 1401, 4300 or 4400 (polyethylene based (graft) copolymers), from Nippon Oil & Fat Corporation; A-C Wax 307, 316 or 325 (polyethylene polymer powders), from Honeywell; Licowax OP, E, PED191, 371 FP, or WE 40, from Clariant; Hystrene (fatty acids), from PMC Group; Licocare RBW 101, 102, 106, 300, 330, 360 Vita and Ceridust 1060 and 1041 TP Vita from Clariant; Repellant polymer PM-870 or FX 5911 (fluorochemical flake), from 3M; and Incroslip or Incromax 100 (biobased slip additives), from Croda. It should be noted that some of these additives may provide other functionality than a friction modifier to the copolyester resins. For example, Modiper 4300 and 4400 may also function as impact modifiers.

The waxes and siloxanes utilized as component (b) above, are generally present in an amount of about 0.1 to about 12 percent by weight. In other embodiments, they are present in amounts of about 0.1 to about 10, or 1 to about 10 percent by weight, based on the total copolyester composition. In embodiments, the component (b) additive comprises a wax and is present in an amount from 0.1 to 12 wt %, or 0.1 to 10 wt %, or 0.1 to 8 wt %, or 0.1 to 6 wt %, or 0.1 to 4 wt %, or 0.1 to 3 wt %, or 0.1 to 2 wt %, or 0.1 to 1.5 wt %, or 0.1 to 1.3 wt %, or 0.1 to 1.2 wt %, or 0.1 to 1.1 wt %, or 0.1 to 1.0 wt %, 0.2 to 4 wt %, or 0.2 to 3 wt %, or 0.2 to 2 wt %, or 0.2 to 1.5 wt %, or 0.2 to 1.3 wt %, or 0.2 to 1.2 wt %, or 0.2 to 1.1 wt %, or 0.2 to 1.0 wt %, or 0.3 to 4 wt %, or 0.3 to 3 wt %, or 0.3 to 2 wt %, or 0.3 to 1.5 wt %, or 0.3 to 1.3 wt %, or 0.3 to 1.2 wt %, or 0.3 to 1.1 wt %, or 0.3 to 1.0 wt %, or 0.4 to 4 wt %, or 0.4 to 3 wt %, or 0.4 to 2 wt %, or 0.4 to 1.5 wt %, or 0.4 to 1.3 wt %, or 0.4 to 1.2 wt %, or 0.4 to 1.1 wt %, or 0.4 to 1.0 wt %, or 0.5 to 4 wt %, or 0.5 to 3 wt %, or 0.5 to 2 wt %, or 0.5 to 1.5 wt %, or 0.5 to 1.3 wt %, or 0.5 to 1.2 wt %, or 0.5 to 1.1 wt %, or 0.5 to 1.0 wt %, based on the total weight of the polyester composition.

In embodiments, the component (b) additive comprises a siloxane and is present in an amount from 0.1 to 12 wt %, or 1 to 12 wt %, or 1 to 11 wt %, or 1 to 10 wt %, or 1 to 9 wt %, or 1 to 8 wt %, or 2 to 12 wt %, or 2 to 11 wt %, or 2 to 10 wt %, or 2 to 9 wt %, or 2 to 8 wt %, or 3 to 12 wt %, or 3 to 11 wt %, or 3 to 10 wt %, or 3 to 9 wt %, or 3 to 8 wt %, or 4 to 12 wt %, or 4 to 11 wt %, or 4 to 10 wt %, or 4 to 9 wt %, or 4 to 8 wt %, or 5 to 12 wt %, or 5 to 11 wt %, or 5 to 10 wt %, or 5 to 9 wt %, or 5 to 8 wt %, or 6 to 12 wt %, or 6 to 11 wt %, or 6 to 10 wt %, or 6 to 9 wt %, or 6 to 8 wt %, based on the total weight of the polyester composition.

With regard to the component (c) impact modifiers, such compounds are generally elastomeric compounds or polymers which serve to absorb or dissipate the kinetic energy of an impact. A wide range of known materials are useful in component (c). Various kinds of impact modifiers may be used to practice the present invention. Preferred impact modifiers are those that include at least one functional group that is capable of reacting with at least one terminal group of the macrocyclic polyester oligomer. Examples of suitable impact modifiers include, but are not limited to, various known graft copolymers, core shell polymers, and block copolymers. These polymers may include at least one monomer selected from the group consisting of an alkene, an alkadiene, an arene, an acrylate, and an alcohol. (See, for example, EP 1,694,771B1). One example includes core-shell polymers with cores comprised of rubbery polymers and shells comprised of styrene copolymers (See, for example, U.S. Pat. No. 5,321,056, incorporated herein by reference.) Other examples include core-shell and functional polyolefins such as those described in US 2014/0256848 A1, incorporated herein by reference. See also EP 2 139 948 B1.

In embodiments, examples of commercially available impact modifiers can include, but are not limited to, ethylene/propylene terpolymers; functionalized polyolefins, such as those containing methyl acrylate and/or glycidyl methacrylate; styrene-based block copolymeric impact modifiers, and various acrylic core/shell type impact modifiers. Residues of such additives are also contemplated as part of the polyester composition.

It should also be noted that certain frictional additives may also function as an impact modifier. As such, in certain embodiments, it is contemplated that an additive identified as a frictional additive may be included as an impact modifier in addition to one of the other identified frictional additives. For example, Modiper 4300 can function as an impact modifier, and it could be added along with a wax additive, such as Licowax OP, where the Licowax Op is the component (b) additive and the Modiper 4300 is the component (c) additive.

Commercially available examples include:
Modiper® 4300 and Modiper® 4400 available from Nippon Oil & Fat Corporation;
Kane Ace® M300, available from Kaneka Americas Holding, Inc.;
Kane Ace® B564, available from Kaneka Americas Holding, Inc.;
Kane Ace® ECO 1000, available from Kaneka Americas Holding, Inc.;
Kane Ace® MR02, available from Kaneka Americas Holding, Inc.;
Kane Ace® MR03, available from Kaneka Americas Holding, Inc.; and
Lotader® 8900, available from Arkema.

The impact modifiers of component (c) above, can be present in an amount of 0.5 to about 15 percent by weight. In other embodiments, they are present in amounts of 0.5 to 14, or 0.5 to 12, or 0.5 to 10, or 0.5 to 8, or 0.5 to 6, or 0.5 to 5, or 0.5 to 4, or 0.5 to 3, or 0.5 to 2, or 0.5 to 1, or 1 to 14, or 1 to 12, or 1 to 10, or 1 to 8, or 1 to 6, or 1 to 5, or 1 to 4, or 1 to 3, or 1 to 2, or 2 to 14, or 2 to 12, or 2 to 10, or 2 to 8, or 2 to 6, or 2 to 5, or 2 to 4, or 2 to 3, or 3 to 14, or 3 to 12, or 3 to 10, or 3 to 8, or 3 to 6, or 3 to 5, or 3 to 4, or 4 to 14, or 4 to 12, or 4 to 10, or 4 to 8, or 4 to 6, or 4 to 5, or 5 to 14, or 5 to 12, or 5 to 10, or 5 to 8, or 5 to 6, or 6 to 14, or 6 to 12, or 6 to 10, or 6 to 8 percent by weight, based on the total weight of the polyester composition.

In embodiments, the polyester composition comprises 0.1 to 5 wt % of component (b) and 1 to 10 wt % of component (c), or 0.5 to 4 wt % of component (b) and 2 to 8 wt % of component (c), or 0.5 to 2.5 wt % of component (b) and 3 to 6 wt % of component (c), or 1 to 2 wt % of component (b) and 3.5 to 5.5 wt % of component (c), based on the total weight of the polyester composition. In embodiments, the component (b) comprises a siloxane and the component (b) comprises an ethylene acrylate terpolymer. In embodiments, the component (b) comprises a siloxane and the component (b) comprises an ethylene, acrylic acid, and glycidyl (meth)acrylate terpolymer. In one embodiment, the component (b) comprises Genioplast S and the component (b) comprises Lotader 8900. In one embodiment, the polyester composition comprises: DX4000 or DX4001 in an amount from 93 to 95 wt %, Genioplast S in an amount from 1 to 2 wt %, and Lotader 8900. In an amount from 4 to 5 wt %.

This invention can be further illustrated by the following examples of preferred embodiments thereof, although it will be understood that these examples are included merely for purposes of illustration and are not intended to limit the scope of the invention unless otherwise specifically indicated.

### Experimental Section

### Section 1. Base Resin Testing

Several commercially available resins were subjected to a battery of testing. This testing was designed to set a baseline for the performance of the copolyester compositions in terms of physical properties and frictional performance.

Physical properties as typically reported on technical data sheets (TDS) were evaluated using injection-molded tensile or flexural bars using established test methodologies as defined by ASTM. For commercially available resins, drying and processing conditions reported on the technical data sheets were utilized for molding. For modified resins, processing conditions utilized were selected using that of the base resin.

Multiple tests were completed for all samples, with modified resins detailed in Section 3 below. These test methods are segmented as follows:
Specific physical properties typically found on technical data sheets. Specific testing included tensile properties (ASTM D638), flexural properties (ASTM D790), notched Izod impact properties (ASTM D256), and heat deflection properties (ASTM D648). In all cases, standard conditioning and test protocols were followed for both commercial resins and modified resins.
Frictional profile of the base resin, as reported as the static coefficient of friction and kinetic coefficient of friction (μₛ and μₖ, respectively), using a custom, in-house test method comparable to that of the traditional and standardized frictional sliding sled test (ASTM D1894). These values were measured using a Bruker Tribometer by intentionally contacting the surfaces of a pair of 4″×4″×⅛″ plaques produced using injection molding. Gloves were worn at all times to avoid direct contact with the test specimens to avoid contaminating frictional data measurements. Once molded, a pair of plaques were utilized to measure frictional coefficients according to the following definitions:
   Static COF (μₛ), measured at the limit in which the contacting force between the two plaques (F_{z}) and relative speed between the two contacting plaques (vₓ) both approach zero, e.g.:

$${F}_{z} = 0.05 N , {v}_{x} = 0.01 mm / sec$$

Kinetic COF (μₖ), defined as the friction measured under constant force and relative speed between the two contacting plaques, e.g.:

$${F}_{z} = 3. N , {v}_{x} = 10. mm / sec$$

A summary of commercial resins evaluated as “control” or “counter” examples is set forth in Table 1 below.

TABLE 1
Summary of “control” or “counter” materials evaluated

| Identifier | Base Resin |
|---|---|
| C-01 | Styrolution Terluran ® ABS GP-35 |
| C-02 | PC 2608 (Makrolon ® 2608 from Covestro) |
| C-03 | Eastman TREVA ™ Engineering Bioplastic |
| | TR6021 |
| C-04 | Eastman Tritan ™ Copolyester TX1501 |
| C-05 | Eastman Tritan ™ Copolyester TX1001 |
| C-06 | Eastman Tritan ™ Copolyester GMX201 |
| C-07 | Eastman Tritan ™ Copolyester DX4001 |
| C-08 | Eastman Tritan ™ Copolyester TX1000 |
| C-09 | Eastman Tritan ™ Copolyester GMX200 |
| C-10 | Eastman Tritan ™ Copolyester DX4000 |

A summary of the physical properties for the control/counter materials are set forth in Table 2 below.

TABLE 2
Summary of physical properties of Table 1 materials.

| | TENSILE | | | | | NOTCHED IZOD | | Flexural | HDT | |
|---|---|---|---|---|---|---|---|---|---|---|
| | Yield | Yield % | Break | Break % | Modulus | Type | Energy | Modulus | 0.455 MPa | 1.820 MPa |
| | Units | | | | | | | | | |
| | | | | | | [NB, P, | | | | |
| ID | [Mpa] | [%] | [MPa] | [%] | [MPa] | H, C] | [J/m] | [MPa] | [° C.] | [° C.] |
| C-01 | 46.1 | 2.4 | 33.4 | 16.2 | 2416.0 | P | 227.1 | 2300 | 89.0 | 78.0 |
| C-02 | 65.0 | 6.3 | 70.0 | 120.0 | 2350.0 | NB | 663.0 | 2350 | 139.0 | 127.0 |
| C-03 | 48.0 | 5.0 | 48.0 | 27.0 | 1881.0 | C | 192.0 | 2090 | 115.0 | 99.0 |
| C-04 | 43.0 | 7.0 | 52.0 | 210 | 1575 | NB | 860 | 1575 | 94.0 | 81.0 |
| C-05 | 44.3 | 5.5 | 56.4 | 172.3 | 1629.0 | NB | 1105.7 | 1550 | 99.0 | 85.0 |
| C-06 | 55.7 | 4.1 | 54.9 | 289.7 | 2249.6 | C | 52.4 | 2442 | 80.8 | 70.4 |
| C-07 | 53.0 | 4.7 | 58.0 | 210.0 | 2040.0 | C | 64.0 | 2342 | 93.0 | 82.0 |
| C-08 | 43.0 | 6.0 | 53.0 | 210 | 1550 | NB | 980 | 1550 | 99.0 | 85.0 |
| C-09 | 52.0 | 4.2 | 58.0 | 283 | 2125 | C | 58 | 2325 | 81.0 | 70.0 |
| C-10 | 52.0 | 4.7 | 58.0 | 275.0 | 2130.0 | C | 90 | 2220 | 96 | 85 |

A review of the physical properties data from Table 2 reveals that resins C-01 and C-02 (ABS and polycarbonate (PC), respectively) exhibit higher stiffness, both in tensile and flexural modulus, than all other materials evaluated. Resins C-03 (cellulosic material) exhibit similar tensile properties, with the exception of modulus, as compared to C-01, as well as similar magnitude of impact toughness as measured by the notched Izod test. The notch sensitivity of resins C-06, C-07, C-09 and C-10 is significantly higher than that of C-01, while the stiffness of resins C-04, C-05 and C-08 is the lowest of the commercial resins evaluated.

The frictional performance of Table 1 materials was evaluated to quantify the static and kinetic coefficient of friction (μₛ and μₖ, respectively). The coefficient of friction (COF) values are listed below in Table 3.

TABLE 3
Summary of frictional properties:

| | Tribometer | Tribometer |
|---|---|---|
| | (0.05N Scan) | (3.00N Scan) |
| | Static COF | Kinetic COFD |
| Sample | [—] | [—] |
| C-01 | 0.18 | 0.14 |
| C-02 | 0.33 | 0.26 |
| C-03 | 0.58 | 0.44 |
| C-04 | Not measured | Not measured |
| C-05 | 1.07 | 0.74 |
| C-06 | 0.55 | 0.43 |
| C-07 | 0.69 | 0.54 |
| C-08 | 1.62 | 1.10 |
| C-09 | Not measured | Not measured |
| C-10 | Not measured | Not measured |

A review of table 3 shows C-01 (ABS) and C-02 (PC) have similar frictional profiles, referring to the static and kinetic coefficient of friction, when measured according to a sliding-sled type test (Table 3). Further, resin C-01 offers lower frictional performance compared to all resins evaluated. As such, to enable functionality for applications that previously utilized ABS material and require similar frictional behavior, it would be necessary to modify the frictional performance of the other resins (e.g., C-03 through C-10) to match the performance of C-01 in frictional testing, while maintaining (or not significantly diminishing) physical properties compared to the non-modified base resins, most notably stiffness and impact toughness.

### Section 2. Modification

Modified, developmental samples were generated by using twin-screw compounding and various additive(s) to alter performance, most notably frictional profile via incorporation of various additives. These additives can vary in chemistry, including ranging from short-chain molecules (e.g., waxes) to high- or ultra-high molecular weight organo-siloxanes (e.g., PDMS). In a compounded formulation, it was found that the additives can function either as internal and/or external lubricants, depending on the specific additive chemistry, molecular weight, loading level, and functionality. Additives utilized are listed below in Table 4.

TABLE 4
Additive utilized to modify resins

| Sample | Additive |
|---|---|
| T-01 | Tegomer H-Si 6441 P |
| T-02 | Genioplast S |
| T-03 | DowSil 4-7081 |
| T-04 | Loxiol P861 |
| T-05 | 3M PM-870 |
| T-06 | Incromax 100 |
| T-07 | Tegomer V-Si 4042 |
| T-08 | Tegomer M-Si 2650 |
| T-09 | Tegomer E-Si 2330 |

Additional additives that could be incorporated into potential formulations, in addition to the above additives, are additives specifically designed to modify impact toughness. Additives employed for impact modification are typically incorporated at loading levels of less than 15 weight %, and span multiple chemistries and forms, including: core-shell, branched, reactive, MBS, acrylic, EGMA, etc. Impact modifiers that were tested either alone or in combination with the additives (from Table 4) are listed in Table 5 below.

TABLE 5
Impact modifier additives

| Sample | Additive |
|---|---|
| I-01 | Modiper 4300 |
| I-02 | Modiper 4300 |
| I-03 | M300 |
| I-04 | B564 |
| I-05 | ECO 100 |
| I-06 | Lotader 8900 |

### Section 3. Examples

Multiple samples of TMCD and EG-containing copolyesters, e.g., Eastman GMX201 (sample C-06), Tritan™ DX4001 (sample C-07) and Tritan™ DX4000 (sample C-10), were generated by modification by use of frictional additives and/or impact modifiers. Physical properties, before and after thermal aging protocol, were measured. Frictional performance of some formulations was also assessed using the Tribometer (as discussed above). Results are reported in the following tables, summarizing performance of modified formulations compared to control examples.

Table 6 summarizes the formulations evaluated in this study, GX-01 through GX-35 which use sample C-06 as a base resin, DX-01 through DX-21 which use sample C-07 as a base resin, and DX-22 through DX-30 which use sample C-10 as a base resin. Specific compositions of frictional additives in comparison to Control or Counter examples is listed. Note that although the “Base Resin” utilized for the modified Tritan™ samples was Tritan™ GMX201 (C-06), Tritan™ DX4001 (C-07), Tritan™ DX4000 (C-10), learnings from this study would provide insight to use of other TMCD and EG base resins, e.g., Tritan™ GMX200.

TABLE 6
Summary of Example Formulations Evaluated

| | | | COF | COF | IM | IM |
|---|---|---|---|---|---|---|
| | Base | Base | Addi- | Addi- | Addi- | Addi- |
| Sample | Resin | Resin % | tive | tive % | tive | tive % |
| C-01 | GP-35 | 100.0 | | 0.00 | | 0.00 |
| C-02 | 2608 | 100.0 | | 0.00 | | 0.00 |
| C-03 | TR6021 | 100.0 | | 0.00 | | 0.00 |
| C-06 | GMX201 | 100.0 | | 0.00 | | 0.00 |
| GX-01 | GMX201 | 97.5 | | 0 | I-01 | 2.50 |
| GX-02 | GMX201 | 95 | | 0 | I-01 | 5.00 |
| GX-03 | GMX201 | 97.5 | | 0 | I-02 | 2.50 |
| GX-04 | GMX201 | 95 | | 0 | I-02 | 5.00 |
| GX-05 | GMX201 | 95 | | 0 | I-03 | 5.0 |
| GX-06 | GMX201 | 90 | | 0 | I-03 | 10.0 |
| GX-07 | GMX201 | 85 | | 0 | I-03 | 15.0 |
| GX-08 | GMX201 | 95 | | 0 | I-04 | 5.00 |
| GX-09 | GMX201 | 90 | | 0 | I-04 | 10.00 |
| GX-10 | GMX201 | 85 | | 0 | I-04 | 15.00 |
| GX-11 | GMX201 | 95 | | 0 | I-05 | 5.00 |
| GX-12 | GMX201 | 90 | | 0 | I-05 | 10.00 |
| GX-13 | GMX201 | 85 | | 0 | I-05 | 15.00 |
| GX-14 | GMX201 | 94 | | 0 | I-05 | 6.00 |
| GX-15 | GMX201 | 92 | | 0 | I-05 | 8.00 |
| GX-16 | GMX201 | 90 | | 0 | I-05 | 10.00 |
| GX-17 | GMX201 | 95 | | 0 | I-06 | 5.00 |
| GX-18 | GMX201 | 90 | | 0 | I-06 | 10.00 |
| GX-19 | GMX201 | 85 | | 0 | I-06 | 15.00 |
| GX-20 | GMX201 | 97 | | 0 | I-06 | 3.00 |
| GX-21 | GMX201 | 96 | | 0 | I-06 | 4.00 |
| GX-22 | GMX201 | 95 | | 0 | I-06 | 5.00 |
| GX-23 | GMX201 | 92 | | 0 | I-05 | 8.00 |
| GX-24 | GMX201 | 94.4 | T-04 | 0.6 | I-06 | 5.00 |
| GX-25 | GMX201 | 85 | | 0 | I-05 | 15.00 |
| GX-26 | GMX201 | 95 | | 0 | I-06 | 5.00 |
| GX-27 | GMX201 | 92.5 | | 0 | I-06 | 7.50 |
| GX-28 | GMX201 | 90 | | 0 | I-06 | 10.00 |
| GX-29 | GMX201 | 95 | | 0 | I-04 | 5.0 |
| GX-30 | GMX201 | 95 | | 0 | I-06 | 5.0 |
| GX-31 | GMX201 | 90 | | 0 | I-06 | 10.00 |
| GX-32 | GMX201 | 98.5 | T-01 | 1.5 | | 0 |
| GX-33 | GMX201 | 97 | T-01 | 3 | | 0 |
| GX-34 | GMX201 | 93.5 | T-01 | 1.5 | I-06 | 5.00 |
| GX-35 | GMX201 | 92 | T-01 | 3 | I-06 | 5.00 |
| GX-36 | GMX201 | 98.5 | T-02 | 1.5 | | 0 |
| GX-37 | GMX201 | 97 | T-02 | 3 | | 0 |
| GX-38 | GMX201 | 93.5 | T-02 | 1.5 | I-06 | 5.00 |
| GX-39 | GMX201 | 92 | T-02 | 3 | I-06 | 5.00 |
| GX-40 | GMX201 | 97 | T-03 | 3 | | 0 |
| GX-41 | GMX201 | 94 | T-03 | 6 | | 0 |
| GX-42 | GMX201 | 92 | T-03 | 3 | I-06 | 5.00 |
| GX-43 | GMX201 | 89 | T-03 | 6 | I-06 | 5.00 |
| GX-44 | GMX201 | 90 | T-03 | 3 | I-06 | 10.00 |
| GX-45 | GMX201 | 90 | T-03 | 6 | I-06 | 10.00 |
| C-07 | DX4001 | 100 | | 0 | | 0 |
| DX-01 | DX4001 | 97.5 | | 0 | I-01 | 2.5 |
| DX-02 | DX4001 | 95 | | 0 | I-01 | 5.0 |
| DX-03 | DX4001 | 97.5 | | 0 | I-01 | 2.5 |
| DX-04 | DX4001 | 95 | | 0 | I-01 | 5.00 |
| DX-05 | DX4001 | 95 | | 0 | I-03 | 5.00 |
| DX-06 | DX4001 | 90 | | 0 | I-03 | 10.00 |
| DX-07 | DX4001 | 85 | | 0 | I-03 | 15.00 |
| DX-08 | DX4001 | 95 | | 0 | I-05 | 5.00 |
| DX-09 | DX4001 | 90 | | 0 | I-05 | 10.00 |
| DX-10 | DX4001 | 85 | | 0 | I-05 | 15.00 |
| DX-11 | DX4001 | 95 | | 0 | I-06 | 5.00 |
| DX-12 | DX4001 | 90 | | 0 | I-06 | 10.00 |
| DX-13 | DX4001 | 85 | | 0 | I-06 | 15.00 |
| DX-14 | DX4001 | 95 | | 0 | I-04 | 5.00 |
| DX-15 | DX4001 | 90 | | 0 | I-04 | 10.00 |
| DX-16 | DX4001 | 85 | | 0 | I-04 | 15.00 |
| DX-17 | DX4001 | 98.5 | T-01 | 1.5 | | 0 |
| DX-18 | DX4001 | 97 | T-01 | 3 | | 0 |
| DX-19 | DX4001 | 93.5 | T-01 | 1.5 | I-06 | 5 |
| DX-20 | DX4001 | 92 | T-01 | 3 | I-06 | 5 |
| DX-21 | DX4001 | 98.5 | T-02 | 1.5 | | 0 |
| DX-22 | DX4001 | 97 | T-02 | 3 | | 0 |
| DX-23 | DX4001 | 93.5 | T-02 | 1.5 | I-06 | 5 |
| DX-24 | DX4001 | 92 | T-02 | 3 | I-06 | 5 |
| DX-25 | DX4001 | 97 | T-03 | 3 | | 0 |
| DX-26 | DX4001 | 94 | T-03 | 6 | | 0 |
| DX-27 | DX4001 | 92 | T-03 | 3 | I-06 | 5 |
| DX-28 | DX4001 | 89 | T-03 | 6 | I-06 | 5 |
| C-10 | DX4000 | 100 | | 0 | | 0 |
| DX-29 | DX4000 | 99.0 | T-04 | 1.00 | | 0 |
| DX-30 | DX4000 | 98.75 | T-04 | 1.25 | | 0 |
| DX-31 | DX4000 | 98.5 | T-04 | 1.50 | | 0 |
| DX-32 | DX4000 | 99.60 | T-05 | 0.40 | | 0 |
| DX-33 | DX4000 | 99.40 | T-05 | 0.60 | | 0 |
| DX-34 | DX4000 | 99.20 | T-05 | 0.80 | | 0 |
| DX-35 | DX4000 | 99.45 | T-06 | 0.55 | | 0 |
| DX-36 | DX4000 | 99.20 | T-06 | 0.80 | | 0 |
| DX-37 | DX4000 | 98.95 | T-06 | 1.05 | | 0 |
| DX-38 | DX4000 | 99.0 | T-07 | 1.0 | | 0 |
| DX-39 | DX4000 | 99.0 | T-08 | 1.0 | | 0 |
| DX-40 | DX4000 | 99.0 | T-09 | 1.0 | | 0 |
| DX-41 | DX4000 | 99.0 | T-01 | 1.0 | | 0 |
| DX-42 | DX4000 | 95.0 | T-01 | 5.0 | | 0 |

Physical properties and performance for all example resins were measured in accordance with the identical procedures and test methods previously mentioned for all control, counter, and/or commercial resins. A summary of the physical properties of all example resins-most notably tensile properties, notched Izod impact toughness, flexural modulus, and heat deflection temperature is shown in Table 7.

TABLE 7
Summary of TDS properties of Example formulations:

| | | | | | | | | Notched Izod | | | | |
|---|---|---|---|---|---|---|---|---|---|---|---|---|
| | Conditions | | Tensile | | | | | Type | | Flexural | HDT | |
| | Time | Temp | Yield | Yield % | Break | Break % | Modulus | [NB, P, | Energy | Modulus | 0.455 MPa | 1.820 MPa |
| Sample | [h] | [° C.] | [MPa] | [%] | [MPa] | [%] | [MPa] | H, C] | [J/m] | [MPa] | [° C.] | [° C.] |
| C-01 | 72 | 23 | 46.1 | 2.4 | 33.4 | 16.2 | 2416 | P | 227.1 | 2300 | 89.0 | 78.0 |
| C-02 | 72 | 23 | 65.0 | 6.3 | 70.0 | 120.0 | 2350 | NB | 663.0 | 2350 | 139.0 | 127.0 |
| C-03 | 72 | 23 | 48.0 | 5.0 | 48.0 | 27.0 | 1881 | C | 192.0 | 2090 | 115.0 | 99.0 |
| C-04 | 72 | 23 | 47.0 | 4.4 | 44.9 | 25.3 | 1829 | C | 259.7 | 1825 | 96.4 | 87.8 |
| C-05 | 72 | 23 | 44.3 | 5.5 | 56.4 | 172.3 | 1629 | NB | 1105.7 | 1550 | 99.0 | 85.0 |
| C-06 | 72 | 23 | 55.7 | 4.1 | 54.9 | 289.7 | 2250 | C | 52.4 | 2442 | 80.8 | 70.4 |
| GX-01 | 72 | 23 | 51.5 | 4.0 | 52.4 | 270.6 | 2046 | C | 63.1 | 2321 | | |
| GX-02 | 72 | 23 | 48.9 | 3.6 | 56.4 | 282.4 | 2028 | C | 113.8 | 2202 | | |
| GX-03 | 72 | 23 | 52.8 | 3.7 | 58.6 | 297.3 | 2188 | C | 60.5 | 2361 | | |
| GX-04 | 72 | 23 | 50.8 | 3.7 | 57.3 | 291.1 | 2128 | C | 107.7 | 2270 | | |
| GX-05 | 72 | 23 | 50.4 | 4.0 | 43.7 | 342.1 | 1969 | C | 68.0 | 2320 | | |
| GX-06 | 72 | 23 | 48.3 | 3.9 | 47.3 | 260.1 | 1789 | C | 119.4 | 2209 | | |
| GX-07 | 72 | 23 | 44.9 | 6.3 | 39.6 | 157.0 | 1746 | C | 71.5 | 2037 | | |
| GX-08 | 72 | 23 | 48.8 | 3.6 | 52.2 | 300.5 | 2072 | NB | 1320.0 | 2230 | | |
| GX-09 | 72 | 23 | 44.5 | 3.5 | 54.4 | 320.5 | 1888 | NB | 1452.5 | 2045 | | |
| GX-10 | 72 | 23 | 40.5 | 3.5 | 51.3 | 315.1 | 1738 | NB | 1329.1 | 1845 | | |
| GX-11 | 72 | 23 | 49.3 | 3.8 | 44.3 | 365.7 | 1937 | C(5), | 694.4 | 2225 | | |
| | | | | | | | | NB(5) | | | | |
| GX-12 | 72 | 23 | 41.7 | 3.6 | 42.2 | 260.2 | 1673 | NB | 1254.7 | 1923 | | |
| GX-13 | 72 | 23 | 43.9 | 3.5 | 52.0 | 337.2 | 1893 | NB | 1260.4 | 2023 | | |
| GX-14 | 72 | 23 | 49.3 | 4.0 | 57.5 | 337.1 | 1976 | NB(6), | 801.2 | 2092 | 80.2 | 70.4 |
| | | | | | | | | C(4) | | | | |
| GX-15 | 72 | 23 | 46.1 | 3.9 | 53.6 | 322.8 | 1912 | NB | 1284.6 | 2029 | 79.7 | 69.8 |
| GX-16 | 72 | 23 | 44.1 | 3.8 | 51.6 | 304.7 | 1865 | NB | 1286.4 | 1936 | 78.0 | 69.0 |
| GX-17 | 72 | 23 | 48.8 | 3.7 | 51.4 | 269.2 | 1987 | NB | 1170.8 | 2188 | | |
| GX-18 | 72 | 23 | 43.4 | 3.6 | 51.9 | 301.3 | 1794 | NB | 1062.7 | 1962 | | |
| GX-19 | 72 | 23 | 39.0 | 3.5 | 46.9 | 280.7 | 1645 | NB | 1021.8 | 1779 | | |
| GX-20 | 72 | 23 | 49.4 | 4.0 | 59.5 | 322.2 | 2043 | C | 76.4 | 2180 | 80.7 | 69.9 |
| GX-21 | 72 | 23 | 49.5 | 4.0 | 56.1 | 295.8 | 2035 | C | 95.4 | 2196 | 80.7 | 70.1 |
| GX-22 | 72 | 23 | 47.5 | 3.9 | 58.7 | 317.6 | 1953 | NB | 1193.3 | 2100 | 80.5 | 69.9 |
| GX-23 | 72 | 23 | 47.2 | 4.0 | 47.2 | 297.8 | 1988 | NB | 1153.7 | 2142 | 78.3 | 68.4 |
| GX-24 | 72 | 23 | | | 58.7 | 317.6 | 1953 | NB | 1193.3 | 2100 | 80.5 | 69.9 |
| GX-25 | 72 | 23 | 40.4 | 3.6 | 40.4 | 242.6 | 1736 | NB | 1161.2 | 2023 | | |
| GX-26 | 72 | 23 | 48.1 | 3.9 | 57.3 | 316.9 | 2000 | NB | 1124.9 | 2100 | | |
| GX-27 | 72 | 23 | 45.7 | 3.8 | 53.4 | 289.8 | 189 | NB | 1036.9 | 2031 | | |
| GX-28 | 72 | 23 | 43.2 | 3.8 | 54.0 | 304.4 | 1781 | NB | 1017.9 | 1962 | | |
| GX-29 | 72 | 23 | 48.8 | 3.7 | 56.3 | 327.0 | 2078 | NB(8) | 1013.6 | 2230 | | |
| | | | | | | | | C(2) | | | | |
| GX-30 | 72 | 23 | 46.7 | BY | 56.4 | 309.4 | 1932 | NB | 1192.7 | 2048 | 80.5 | 69.2 |
| GX-31 | 72 | 23 | 41.6 | NY | 53.6 | 303.3 | 1783 | NB | 1169.7 | 1833 | 79.4 | 68.1 |
| GX-32 | 72 | 23 | 54.2 | 4.1 | 44.6 | 278.3 | 2089 | C | 52.4 | 2505 | 78.5 | 68.5 |
| GX-33 | 72 | 23 | 52.9 | 3.8 | 12.6 | 55.8 | 2300 | C | 55.5 | 2495 | 76.8 | 68.3 |
| GX-34 | 72 | 23 | 46.7 | | 39.5 | 371.7 | 2005 | P | 1075.8 | 2166 | 78.7 | 69.3 |
| GX-35 | 72 | 23 | 45.3 | 3.6 | 18.6 | 116.1 | 2027 | C | 86.5 | 2153 | 77.5 | 68.4 |
| GX-36 | 72 | 23 | 50.58 | 3.9 | 39.46 | 377.21 | 2178 | C | 55.2 | 2445 | 81 | 71.4 |
| GX-37 | 72 | 23 | 50.7 | 4.1 | 41.1 | 318.7 | 2133 | C | 62.6 | 2398 | 85.2 | 70.1 |
| GX-38 | 72 | 23 | 44.9 | 3.7 | 52.7 | 290.7 | 2012 | P | 1225.3 | 2096 | 80.3 | 70.9 |
| GX-39 | 72 | 23 | 42.7 | 3.6 | 52.1 | 290.6 | 1964 | P | 1221.4 | 2056 | 79.9 | 70.4 |
| GX-42 | 72 | 23 | 45.0 | 3.5 | 52.6 | 299.8 | 2214 | C(4), | 464.3 | 2061 | 80.8 | 73.1 |
| | | | | | | | | P(3), | | | | |
| | | | | | | | | NB | | | | |
| GX-43 | 72 | 23 | 41.2 | 3.3 | 46.3 | 250.1 | 2091 | NB | 787.4 | 1954 | 81.6 | 72.6 |
| GX-44 | 72 | 23 | 39.4 | 3.5 | 49.6 | 313.2 | 1829 | P(7), | 668.2 | 1874 | 80.8 | 71.7 |
| | | | | | | | | NB(2) | | | | |
| GX-45 | 72 | 23 | 37.2 | 3.4 | 40.6 | 244.7 | 1881 | NB | 658.8 | 1742 | 80.4 | 69.9 |
| C- | 72 | 23 | 53.0 | 4.7 | 58.0 | 210.0 | 2040 | C | 64.0 | 2342 | 93.0 | 82.0 |
| 07 | | | | | | | | | | | | |
| DX-01 | 72 | 23 | 48.9 | 4.5 | 52.2 | 178.2 | 1933 | C | 89.5 | 2213 | | |
| DX-02 | 72 | 23 | 46.3 | 4.4 | 50.7 | 181.5 | 1827 | NB | 1200.3 | 2091 | | |
| DX-03 | 72 | 23 | 49.7 | 4.5 | 53.2 | 196.0 | 1928 | C | 93.6 | 2235 | | |
| DX-04 | 72 | 23 | 48.1 | 4.5 | 50.3 | 189.9 | 1867 | NB | 1213.9 | 2158 | | |
| DX-05 | 72 | 23 | 49.5 | 4.5 | 52.5 | 208.8 | 1891 | C | 104.7 | 2235 | | |
| DX-06 | 72 | 23 | 47.1 | 4.4 | 50.8 | 174.7 | 1823 | C | 207.8 | 2140 | | |
| DX-07 | 72 | 23 | 44.6 | 4.2 | 48.0 | 160.6 | 1745 | C | 199.7 | 2038 | | |
| DX-08 | 72 | 23 | 48.3 | 4.4 | 55.3 | 252.0 | 1914 | NB | 1223.3 | 2071 | | |
| DX-09 | 72 | 23 | 44.6 | 4.2 | 48.0 | 197.8 | 1801 | NB | 1230.5 | 1934 | | |
| DX-10 | 72 | 23 | 41.1 | 4.1 | 45.8 | 197.1 | 1669 | NB | 1114.5 | 1792 | | |
| DX-11 | 72 | 23 | 46.4 | 4.2 | 50.8 | 203.3 | 1887 | NB | 1201.3 | 2010 | 93.8 | 82.9 |
| DX-12 | 72 | 23 | 41.3 | 4.2 | 53.2 | 243.7 | 1669 | NB | 1116.2 | 1790 | 92.2 | 80.2 |
| DX-13 | 72 | 23 | 36.8 | 4.1 | 42.6 | 171.6 | 1494 | NB | 1069.7 | 1610 | | |
| DX-14 | 72 | 23 | 47.6 | 4.1 | 56.9 | 232.2 | 1981 | NB | 1271.2 | 2097 | | |
| DX-15 | 72 | 23 | 43.2 | 4.0 | 56.4 | 251.5 | 1843 | NB | 1172.6 | 1914 | | |
| DX-16 | 72 | 23 | 40.4 | 3.9 | 47.3 | 198.6 | 1732 | NB | 1076.6 | 1793 | | |
| DX-17 | 72 | 23 | 52.3 | 4.4 | 55.1 | 256.7 | 2284 | C | 70.28 | 2400 | 89.6 | 77.9 |
| DX-18 | 72 | 23 | 52.2 | 4.2 | 55.1 | 69.3 | 2173 | NB | 64.8 | | | |
| DX-19 | 72 | 23 | 44.6 | 4.2 | 50.5 | 204.4 | 1925 | C(1) | 1150.12 | 2072 | 89.8 | 77 |
| | | | | | | | | P(8) | | | | |
| DX-20 | 72 | 23 | 44.2 | 4.2 | 48.7 | 218.2 | 2014 | P | 1198.4 | 2047 | 85.9 | 74.4 |
| DX-21 | 72 | 23 | 50.9 | 4.4 | 52.3 | 189.3 | 2252 | C | 75.3 | 2300 | 90.8 | 77.5 |
| DX-22 | 72 | 23 | 49.7 | 4.5 | 51.1 | 190.2 | 2126 | NB | 88.3 | | | |
| DX-23 | 72 | 23 | 43.7 | 4.3 | 50 | 188.9 | 1917 | P | 1263.8 | 2034 | 92 | 79.5 |
| DX-24 | 72 | 23 | 41.8 | 4.2 | 47.1 | 170.5 | 2031 | P | 1270.2 | 1972 | 91.1 | 78.8 |
| DX-25 | 72 | 23 | 48.0 | 4.3 | 51.2 | 205.1 | 2060 | C | 107.8 | 2201 | 92.7 | 81.5 |
| DX-26 | 72 | 23 | 45.1 | 4.1 | 45.1 | 161.5 | 1991 | C | 187.0 | 2124 | 92.1 | 80.4 |
| DX-27 | 72 | 23 | 40.9 | 4.3 | 49.4 | 196.9 | 1799 | P | 1110.2 | 1987 | 90.3 | 77.4 |
| DX-28 | 72 | 23 | 38.12 | 4.11 | 47.42 | 249.14 | 1707 | C(1) | 982.88 | 1854 | 91.5 | 78.7 |
| | | | | | | | | P(8) | | | | |
| DX-38 | 72 | 23 | 54.2 | | 54.3 | 247 | 2145 | C | 47 | | 88.5 | 78.0 |
| DX-39 | 72 | 23 | 51.6 | | 53.0 | 212 | 2132 | C | 59 | | 93.2 | 82.2 |
| DX-40 | 72 | 23 | 51.3 | | 53.8 | 218 | 2126 | C | 65 | | 93.6 | 79.4 |
| DX-41 | 72 | 23 | 53.0 | | 54.5 | 227 | 2186 | C | 54 | | 90.4 | 79.4 |
| DX-42 | 72 | 23 | 50.4 | | 8.1 | 16 | 2118 | C | 68 | | 85.1 | 73.1 |

Table 7 shows performance of example formulations versus existing, commercial formulations. A review of Table 7 reveals the following unexpected performance:
An array of formulations with varying COF additive type and loading level, that maintain or exceed elongation at break in comparison to unmodified copolyester resins (C-06 or C-07)
Less than 10% reduction in tensile yield across most example formulations when compared to control copolyester samples (C-06 and C-07), while meeting or exceeding the performance of C-1
Extensive improvement in notched Izod impact energy when compared to C-06 and C-07—both in failure mode (no breaks), as well as impact energy-both far exceeding that of C-01.
Minimal reduction in heat deflection temperature versus unmodified copolyester examples (C-06 or C-07) for all formulations, with performance on par with that of C-01
Ability to improve Notched Izod break type from complete to no break (reduced notch sensitivity) without use of impact modifier (e.g., DX-18, DX-22)
Ability to increase tensile and flexural modulus with friction modifiers (e.g., DX-17, DX-18, DX-19, DX-20, DX38, DX-39, DX-40, DX-41, DX-42)

Physical properties were also assessed after a simple accelerated aging protocol. This was completed by subjecting all samples to a thermal aging protocol, and then performing physical property testing on the thermally aged test bars, according to standard ASTM test methods as previously summarized. The goal of completing testing both before and after thermal exposure was to determine if any substantial change in performance and physical properties was noted in the modified copolyester examples, resultant from the frictional modification and additives. Table 8 summarizes tensile properties as measured after standard conditioning (72 hours at 23° C. and 50% RH) and after a thermal aging protocol (200 hours at 60° C.).

TABLE 8
Summary of TDS properties of example formulations after thermal aging.

| | | | | | | | | Sample | |
|---|---|---|---|---|---|---|---|---|---|
| | | | | | | | | Notched Izod | |
| | Conditions | | Tensile | | | | | Type | |
| | Time | Temp. | Yield | Yield | Break | Break % | Modulus | [NB, P, | Energy |
| | [h] | [° C.] | [MPa] | % [%] | [MPa] | [%] | [MPa] | H, C] | [J/m] |
| C-01 | 72 | 23 | 46.1 | 2.4 | 33.4 | 16.2 | 2416.0 | P | 227.1 |
| | 20 | 60 | 46.7 | 2.4 | 34.1 | 11.0 | 2415.0 | H | 209.9 |
| | 200 | 60 | 47.3 | 2.4 | 34.2 | 10.3 | 2292.0 | P | 199.1 |
| | 900 | 60 | 46.9 | 2.3 | 34.9 | 6.8 | 2383.0 | P | 207.8 |
| C-06 | 72 | 23 | 55.7 | 4.1 | 54.9 | 289.7 | 2249.6 | C | 52.4 |
| | 200 | 50 | 64.0 | 4.2 | 42.4 | 188.9 | 2277.2 | C | 48.2 |
| | 900 | 50 | 65.7 | 4.3 | 38.6 | 138.3 | 2333.8 | C | 48.6 |
| GX-26 | 72 | 23 | 48.1 | 3.9 | 57.3 | 316.9 | 2000.0 | NB | 1124.9 |
| | 200 | 60 | 58.4 | NY | 59.4 | 332.5 | 1870.0 | C | 59.3 |
| GX-28 | 72 | 23 | 43.2 | 3.8 | 54.0 | 304.4 | 1781.0 | NB | 1017.9 |
| | 200 | 60 | 49.4 | NY | 52.2 | 306.7 | 1647.0 | P(9), | 665.9 |
| | | | | | | | | C(1) | |
| GX-30 | 72 | 23 | 46.7 | NY | 56.4 | 309.4 | 1932.0 | NB | 1192.7 |
| | 200 | 60 | 50.3 | | | | | NB(4), | 448.3 |
| | | | | | | | | C(5) | |
| GX-31 | 72 | 23 | 41.6 | NY | 53.6 | 303 | 1783.0 | NB | 1169.7 |
| | 200 | 60 | 44.9 | | | | | NB | 927 |
| GX-32 | 72 | 23 | 54.2 | 4.1 | 44.6 | 278.3 | 2089 | C | 52.4 |
| | 200 | 60 | 68.9 | 4.4 | 28.3 | 23.9 | 2295 | C | 36.4 |
| GX-33 | 72 | 23 | 52.9 | 3.8 | 12.6 | 55.8 | 2300 | C | 55.5 |
| | 200 | 60 | 65.7 | 4.2 | 55.7 | 4.6 | 2272 | C | 41.3 |
| GX-34 | 72 | 23 | 46.7 | | 39.5 | 371.7 | 2005 | P | 1075.8 |
| | 200 | 60 | 55.1 | 3.9 | 32.7 | 180.4 | 1989 | C | 73.1 |
| GX-35 | 72 | 23 | 45.3 | 3.6 | 18.6 | 116.1 | 2027 | C | 86.5 |
| | 200 | 60 | 53.2 | 3.7 | 3.7 | 11 | 2005 | C | 53.5 |
| GX-36 | 72 | 23 | 50.58 | 3.9 | 39.46 | 377.21 | 2178 | C | 55.2 |
| | 200 | 60 | 64.2 | 4.1 | 17.8 | 20 | 2287 | C | 44.5 |
| GX-37 | 72 | 23 | 50.7 | 4.1 | 41.1 | 318.7 | 2133 | C | 62.6 |
| | 200 | 60 | 61.2 | 4 | 33.5 | 29.9 | 2199 | C | 47.6 |
| GX-38 | 72 | 23 | 44.9 | 3.7 | 52.7 | 290.7 | 2012 | P | 1225.3 |
| | 200 | 60 | 51.7 | 3.7 | 26.3 | 166.3 | 1959 | C(7) | 282.17 |
| | | | | | | | | P(3) | |
| GX-39 | 72 | 23 | 42.7 | 3.6 | 52.1 | 290.6 | 1964 | P | 1221.4 |
| | 200 | 60 | 49.2 | 3.6 | 38 | 242.3 | 1874 | P | 951.3 |
| GX-42 | 72 | 23 | 45.0 | 3.5 | 52.6 | 299.8 | 2214.0 | C(4), | 464.3 |
| | | | | | | | | P(3), | |
| | | | | | | | | NB(1) | |
| | 200 | 60 | 47.6 | 3.5 | 35.7 | 154.9 | 2103.0 | C | 128.7 |
| | 900 | 60 | 51.5 | 3.6 | 33.5 | 109.2 | 1996.3 | C | 110.4 |
| GX-43 | 72 | 23 | 41.2 | 3.3 | 46.3 | 250.1 | 2091.0 | NB | 787.4 |
| | 200 | 60 | 43.5 | 3.4 | 31.8 | 134.6 | 2014.0 | C(9), | 221.6 |
| | | | | | | | | P(1) | |
| | 900 | 60 | 46.6 | 3.5 | 31.7 | 82.5 | 1865.2 | C | 154.3 |
| GX-44 | 72 | 23 | 39.4 | 3.5 | 49.6 | 313.2 | 1829.0 | P(7), | 668.2 |
| | | | | | | | | NB(2) | |
| | 200 | 60 | 42.2 | 3.5 | 33.8 | 168.6 | 1909.0 | C(6), | 238.3 |
| | | | | | | | | P(3) | |
| | 900 | 60 | 45.1 | 3.5 | 31.5 | 114.4 | 1754.6 | C | 158.6 |
| GX-45 | 72 | 23 | 37.2 | 3.4 | 40.6 | 244.7 | 1881.0 | NB | 658.8 |
| | 200 | 60 | 39.4 | 3.4 | 29.5 | 123.6 | 1821.0 | P | 392.0 |
| | 900 | 60 | 42.0 | 3.5 | 30.4 | 78.6 | 1684.5 | P(6), | 275.2 |
| | | | | | | | | C(1) | |
| C-07 | 72 | 23 | 53.0 | 4.7 | 58 | 210 | 2040 | C | 64.0 |
| | 200 | 60 | 63.0 | 4.5 | 94.3 | 40.3 | 2225 | C | 48.4 |
| DX-17 | 72 | 23 | 52.3 | 4.4 | 55.1 | 256.7 | 2284 | C | 70.28 |
| | 200 | 60 | 62.8 | 4.5 | 43.1 | 125.2 | 2175 | C | 47.7 |
| DX-18 | 72 | 23 | 52.2 | 4.2 | 55.1 | 269.3 | 2173.0 | C | 64.8 |
| | 200 | 60 | 59.5 | 4.3 | 36.8 | 77.9 | 2224.0 | C | 48.6 |
| DX-19 | 72 | 23 | 44.6 | 4.2 | 50.5 | 204.4 | 1925 | C(1) | 1150.12 |
| | | | | | | | | P(8) | |
| | 200 | 60 | 51.7 | 4.1 | 46.1 | 143.9 | 1919 | P | 1183.2 |
| DX-20 | 72 | 23 | 44.2 | 4.2 | 48.7 | 218.2 | 2014 | P | 1198.4 |
| | 200 | 60 | 51.7 | 4.4 | 39.9 | 147.1 | 1705 | C(7) | 434.3 |
| | | | | | | | | P(3) | |
| DX-21 | 72 | 23 | 50.9 | 4.4 | 52.3 | 189.3 | 2252 | C | 75.3 |
| | 200 | 60 | 59.5 | 4.3 | 44.7 | 145.3 | 2134 | C | 54.14 |
| DX-22 | 72 | 23 | 49.7 | 4.5 | 51.1 | 190.2 | 2126.0 | C | 88.3 |
| | 200 | 60 | 55.3 | 4.2 | 43.1 | 81.9 | 2189 | C | 60.7 |
| DX-23 | 72 | 23 | 43.7 | 4.3 | 50 | 188.9 | 1917 | P | 1263.8 |
| | 200 | 60 | 49 | 4 | 51.3 | 220.4 | 1835 | P | 1225.19 |
| DX-24 | 72 | 23 | 41.8 | 4.2 | 47.1 | 170.5 | 2031 | P | 1270.2 |
| | 200 | 60 | 46.7 | 4.4 | 48.3 | | 1547 | P | 1249.2 |
| DX-25 | 72 | 23 | 48.0 | 4.3 | 51.2 | 205.1 | 2060.0 | C | 107.8 |
| | 200 | 60 | 54.9 | 4.0 | 40.5 | 123.7 | 2127.0 | C | 69.0 |
| | 900 | 60 | 57.0 | 4.0 | 39.0 | 120.3 | 2245.0 | C | 65.0 |
| DX-26 | 72 | 23 | 45.1 | 4.1 | 45.1 | 161.5 | 1991.0 | C | 187.0 |
| | 200 | 60 | 51.1 | 3.8 | 34.1 | 87.1 | 2025.0 | C | 117.4 |
| | 900 | 60 | 52.9 | 3.8 | 35.8 | 55.2 | 2164.0 | C | 113.1 |
| DX-27 | 72 | 23 | 40.9 | 4.3 | 49.4 | 196.9 | 1799 | P | 1110.2 |
| | 200 | 60 | 47.6 | 3.9 | 50.2 | 205.7 | 1814 | P | 914.4 |
| DX-28 | 72 | 23 | 38.12 | 4.11 | 47.42 | 249.14 | 1706.8 | C(1) | 982.88 |
| | | | | | | | | P(8) | |
| | 200 | 60 | 43.1 | 3.8 | 47.2 | 216 | 1705 | P | 940.4 |

A review of Table 8 reveals that there was generally minimal shift in tensile properties when compared to sample C-01 and unmodified copolyester sample C-06, except for GX-33, GX-34, GX-35, and GX-36, and unmodified copolyester sample C-07. GX-33 and GX-34 contained T-01, while GX-35 and GX-36 contained T-01 and 1-06. The inclusion of T-01 appears to unexpectedly significantly accelerate aging, and further addition of 1-06 appears to further accelerate aging for the GX copolyesters. This same behavior was not observed when DX4001 was used as the copolyester, as seen in samples DX-17, DX-18, DX-19, and DX-20. Modified copolyester samples exhibited reduction in impact toughness across all samples evaluated after aging, however performance both in failure mode and impact energy of modified samples, except for GX-33, GX-34, GX-35, and GX-36, still far exceed that of unmodified copolyesters (C-06, C-07). Not all combinations of copolyester, friction modifier, and impact modifier resulted in minimal reduction in performance.

Finally, frictional performance of certain modified samples of GMX201 and DX4001 were compared to control sample C-06 and C-07. The results are listed below in Table 9. Table 9 also includes data for haze % for certain DX4001 samples.

TABLE 9
Summary of Frictional/Haze Properties for DX4000.

| | Tribometer | | Tribometer | | |
|---|---|---|---|---|---|
| | (0.05N Scan) | Static | (3.00N Scan) | Kinetic | |
| | Static COF | COF | Kinetic COF | COF | Haze |
| Sample | (Average) | (St. Dev.) | (Average) | (St. Dev.) | (%) |
| C-06 | 0.473 | 0.117 | 0.365 | 0.046 | — |
| GX-17 | 0.591 | 0.066 | 0.692 | 0.025 | — |
| GX-18 | 0.520 | 0.086 | 0.665 | 0.014 | — |
| GX-32 | 0.113 | 0.016 | 0.104 | 0.004 | — |
| GX-33 | 0.087 | 0.006 | 0.082 | 0.002 | — |
| GX-34 | 0.144 | 0.017 | 0.112 | 0.015 | — |
| GX-35 | 0.089 | 0.014 | 0.057 | 0.005 | — |
| GX-36 | 0.396 | 0.079 | 0.363 | 0.041 | — |
| GX-37 | 0.185 | 0.014 | 0.155 | 0.005 | — |
| GX-38 | 0.312 | 0.088 | 0.284 | 0.056 | — |
| GX-39 | 0.318 | 0.042 | 0.208 | 0.019 | — |
| GX-40 | 0.405 | 0.064 | 0.341 | 0.056 | — |
| GX-41 | 0.179 | 0.021 | 0.205 | 0.015 | — |
| GX-42 | 0.503 | 0.099 | 0.653 | 0.056 | — |
| GX-43 | 0.406 | 0.124 | 0.523 | 0.022 | — |
| C-07 | 0.668 | 0.139 | 0.558 | 0.028 | — |
| DX-11 | 0.751 | 0.191 | 0.424 | 0.073 | — |
| DX-12 | 0.657 | 0.061 | 0.452 | 0.035 | — |
| DX-17 | 0.219 | 0.019 | 0.165 | 0.028 | — |
| DX-18 | 0.118 | 0.043 | 0.094 | 0.003 | — |
| DX-19 | 0.273 | 0.017 | 0.202 | 0.004 | — |
| DX-20 | 0.088 | 0.021 | 0.094 | 0.007 | — |
| DX-21 | 0.260 | 0.024 | 0.240 | 0.015 | — |
| DX-22 | 0.096 | 0.010 | 0.103 | 0.009 | — |
| DX-23 | 0.566 | 0.029 | 0.442 | 0.013 | — |
| DX-24 | 0.327 | 0.026 | 0.248 | 0.013 | — |
| DX-25 | 0.751 | 0.191 | 0.424 | 0.073 | — |
| DX-26 | 0.657 | 0.061 | 0.452 | 0.035 | — |
| DX-27 | 0.435 | 0.020 | 0.410 | 0.028 | — |
| DX-28 | 0.504 | 0.092 | 0.458 | 0.035 | — |
| DX-29 | 0.14 | 0.03 | 0.20 | 0.02 | 0.44 |
| DX-30 | 0.27 | 0.52 | 0.20 | 0.03 | 0.42 |
| DX-31 | 0.14 | 0.31 | 0.17 | 0.04 | 0.42 |
| DX-32 | 0.21 | 0.17 | 0.16 | 0.02 | — |
| DX-33 | 0.05 | 0.02 | 0.13 | 0.01 | — |
| DX-34 | 0.22 | 0.17 | 0.11 | 0.02 | — |
| DX-35 | 0.08 | 0.02 | 0.22 | 0.05 | 0.41 |
| DX-36 | 0.16 | 0.08 | 0.17 | 0.05 | 0.29 |
| DX-37 | 0.09 | 0.03 | 0.16 | 0.04 | 0.41 |
| DX-38 | 0.34 | 0.05 | 0.30 | 0.02 | — |
| DX-39 | 0.06 | 0.02 | 0.09 | 0.02 | — |
| DX-40 | 0.23 | 0.03 | 0.21 | 0.03 | — |
| DX-41 | 0.14 | 0.05 | 0.16 | 0.01 | — |
| DX-42 | 0.07 | 0.02 | 0.05 | 0.00 | — |

A review of Table 9 reveals that inclusion of impact modifier I-06 increased the static and kinetic friction in samples GX-17 and GX-18, as compared with C-06, and in samples DX-11 and DX-12, as compared with C-07. This same behavior was seen when I-06 was used in addition to friction modifier T-02, with an increase in static and kinetic friction for samples GX-38 and GX-39, as compared with GX-36 and GX-37, as well as for samples DX-23 and DX-24, as compared with DX-21 and DX-22. However, unexpected synergistic effects were observed for friction modifier T-03 and impact modifier 1-06 in samples DX-25, DX-26, DX-27, and DX-28. In these samples further decrease in static and kinetic friction was observed with the addition of impact modifier 1-6, as compared with only friction modifier T-03. This same effect was not observed when GMX201 was used as the copolyester, as shown in samples GX-40, GX-41, GX-42, and GX-43. In addition, the inclusion of impact modifier 1-06 with friction modifier T-1 had no effect on the friction, as shown in samples GX-34 and GX-35, as compared with GX-32 and GX-33, as well as DX-19 and DX-20, as compared with DX-17 and DX-18. This unexpected behavior can provide a way to create/configure materials with tunable friction and impact performance, a specifically providing for low friction and high impact performance, exceeding that of C-01. A further review of Table 9 reveals that haze values for samples using T-1, T-7, T-8, and T-9 were unexpectedly low, providing high transparency materials with friction similar to C-01.

The invention has been described in detail with particular reference to certain embodiments thereof, but it will be understood that variations and modifications can be affected within the spirit and scope of the invention.

1. A polymer composition comprising:
(a) a copolyester comprising: (i) diacid residues comprising from about 90 to 100 mole percent of terephthalic acid residues and from 0 to about 10 mole percent isophthalic acid residues; and (ii) diol residues comprising 58 to 95 mole percent of ethylene glycol residues; and 5 to 42 mole percent of 2,2,4,4-tetramethyl-1,3-cyclobutanediol residues, wherein the copolyester comprises a total of 100 mole percent diacid residues and a total of 100 mole percent diol residues.
(b) about 0.1 to about 12 weight percent of a frictional additive chosen from waxes and siloxanes; and
(c) about 0.5 to about 15 weight percent of at least one impact modifier.

2. The composition according to claim 1, wherein the frictional additive is a wax.

3. The composition according to claim 2, wherein the frictional additive is present in an amount from about 0.1 to about 3 weight percent.

4. The composition according to claim 1, wherein the frictional additive is a siloxane.

5. The composition according to claim 4, wherein the frictional additive is present in an amount from about 0.1 to about 7 weight percent.

6. The composition according to claim 4, wherein the frictional additive is a polyester modified siloxane.

7. The composition according to claim 4, wherein the frictional additive is a non-reactive siloxane.

8. The composition according to claim 4, wherein the frictional additive is an aryl-modified siloxane.

9. The composition according to claim 1, wherein the polyester composition is a copolyester which comprises diol residues comprising from 10 to 42 mole percent TMCD residues and 58 to 90 mole percent EG residues.

10. The composition according to claim 9, wherein the polyester composition is a copolyester which comprises diol residues comprising from 20 to 30 mole percent TMCD residues and 70 to 80 mole percent EG residues.

11. The composition according to claim 9, wherein the polyester composition is a copolyester which comprises diol residues comprising from 30 to 40 mole percent TMCD residues and 60 to 70 mole percent EG residues.

12. The composition according to claim 1, wherein the composition comprises: (a) 5 to 95 weight percent of the copolyester (a); and (d) 5 to 95 wt % of at least one polymeric component which is other than (a).

13. The composition according to claim 12, wherein (d) is chosen from polyamides; polystyrenes; styrene acrylonitriles; acrylonitrile butadiene styrenes; poly(methylmethacrylate) s; acrylics; poly(ether-imides); polyamides; polystyrenes; polystyrene copolymers; styrene acrylonitrile copolymers; acrylonitrile butadiene styrene copolymers; poly(methylmethacrylate) s; acrylic copolymers; poly(ether-imides); polyphenylene oxides; poly(phenylene oxide)/polystyrene blends; polycarbonates; poly(ester-carbonates); polyphenylene sulfide/sulfones; polysulfones; polysulfone ethers; and poly(ether-ketones) or a mixture thereof.

14. The composition according to claim 1, wherein said composition has a static COF of 0.6 or less and a kinetic COF of 0.5 or less.

15. The composition according to claim 1, wherein said composition has a haze of 5% or less.

16. The composition according to claim 1, wherein said composition has a b* of 6 or less.

17. The composition according to claim 1, wherein said composition comprises an additional additive chosen from antioxidants, thermal stabilizers, mold release agents, antistatic agents, whitening agents, colorants, flow aids, processing aids, plasticizers, anti-fog additives, minerals, UV stabilizers, lubricants, chain extenders, nucleating agents, reinforcing fillers, other fillers, glass fiber, carbon fiber, flame retardants, dyes, pigments, colorants, additional resins and combinations thereof.

18. A shaped or formed article comprising the polymer composition according to claim 1.

19. The article according to claim 18, wherein the article is chosen from an extruded, calendered, and/or molded articles.

20. The articles according to claim 19, wherein the article is chosen from injection molded articles, extruded articles, cast extrusion articles, profile extrusion articles, melt spun articles, thermoformed articles, extrusion molded articles, injection blow molded articles, injection stretch blow molded articles, extrusion blow molded articles, and extrusion stretch blow molded articles.
